(19) United States
(12) Patent Application Publication
(10) Pub. No.: US 2025/0141029 A1
(43) Pub. Date: May 1, 2025

(54) BATTERY MODULE HAVING AN INWARDLY DEFORMING COVER

(71) Applicant: GM GLOBAL TECHNOLOGY OPERATIONS LLC, Detroit, MI (US)

(72) Inventors: Ryan Patrick Hickey, Austin, TX (US); Julian Roy Sherborne, South Lyon, MI (US); Diptak Bhattacharya, Royal Oak, MI (US)

(21) Appl. No.: 18/499,375

(22) Filed: Nov. 1, 2023

(51) Int. Cl. H01M 50/282; H01M 10/658; H01M 50/209; H01M 50/342

(52) U.S. Cl. CPC H01M 50/282; H01M 10/658; H01M 50/209; H01M 50/3425

(57) ABSTRACT

A battery module includes a container, a plurality of battery cells within the container, and a cover attached to sides of the container and extending in a plane over the plurality of battery cells wherein the cover comprises an inner layer and an outer layer. Upon a thermal event in one of the cells the battery cover can deflect inward toward the cells.

### INTRODUCTION

The subject disclosure relates to battery modules and particularly battery modules useful in vehicles.

Rechargeable battery cells can be useful in a variety of modern technical applications such as electronic devices, electric bicycles, hybrid cars, electric cars, and the like. In certain applications, the battery cells are contained in one or more battery modules including a plurality of battery cells. Accordingly, “battery module” as used herein means multiple battery cells connected in series and/or parallel housed in a mechanical structure. Optionally, the battery module can further include thermal management features, such as cold plates, sensors for voltage, temperature, or pressure, or and the like. The battery module can include a cover to protect the module. Battery cells sometimes undergo unfavorable thermal runaway, where the heat generated by a source (e.g., a battery cell) is greater than the ability of the module to dissipate the heat to its surroundings. Thermal runaway can occur, for example, when the battery is short circuited or damaged. This can result in unfavorable temperature increases in the battery module and undesirable deformation of a module cover. Particularly, the battery cover can undergo thermal expansion which when combined with an ejection mass from a damaged cell can cause the cover to bow outward from the module. For example, as shown in FIG. 1, when a thermal event occurs for a module of the prior art having a single layer cover 20 which is affixed at points 24, the cover 20 bows outward from the cells 41 and thermal barrier 42. This outward deformation increases the gaps 60 and 61 and can expose adjacent cells 41 to heat including ejected hot particle mass which can propagate the thermal runaway.

### SUMMARY

In one exemplary embodiment, disclosed is a battery module including a container, a plurality of battery cells within the container, and a cover attached to sides of the container and extending in a plane over the plurality of battery cells wherein the cover comprises an inner layer and an outer layer.

In addition, the battery module can include one or more of the following the features.

The battery module can include a thermal barrier separating a first group of the plurality of battery cells from a second group of the plurality of battery cells. The battery module can include a gap between the cover and a top edge of the plurality of battery cells and the thermal barrier extends upward into the gap toward the cover.

The battery module upon occurrence of a thermal even within one or more of the plurality of battery cells, the cover deforms inward toward the plurality of cells.

The inner layer of the battery module can be attached to the outer layer at least two fixation locations. The at least two fixation locations can be at two opposing edges of the cover. In addition, to the fixation locations at opposing edges of the in the inner layer can be attached to the outer layer at one or more additional locations within a periphery of the cover. The attachment at the one or more additional locations within the periphery of the covers can be weld points. The inner layer can be attached to the outer layer via by a laminating material located between the inner layer and the outer layer. The laminating material can include an adhesive material, an insulating material, or both. The inner layer can be attached to the outer layer by roll-bonding.

The inner layer and the outer layer be formed of the same material or the inner layer can be a first material and the outer layer can be a second material. Both the first material and the second material can be metal. The metal can be selected independently for each of the inner layer and the outer layer from carbon steel, alloyed steel, copper, aluminum, and zinc.

A coefficient of thermal expansion of the inner layer can be larger than a coefficient of thermal expansion of the outer layer.

The cover can have a thickness of 0.4 to 5 mm. The inner layer can have a thickness of 0.2 to 2.5 mm and the outer layer can have a thickness of 0.1 to 2.5 mm. The thickness of the inner layer can be larger than the thickness of the outer layer.

The battery cover can include one or more vents to enable gas to pass out of the module.

In a another exemplary embodiment, disclosed is a battery module including a container, a plurality of battery cells within the container, a thermal barrier separating a first group of the plurality of battery cells from a second group of the plurality of battery cells, and a cover attached to sides of the container and extending in a plane over the plurality of battery cells wherein the cover comprises an inner layer and an outer layer wherein the inner layer is attached to the outer layer in at least two fixation location, wherein there is a gap between the cover and a top edge of the plurality of battery cells and the thermal barrier extends upward into the gap toward the cover, wherein upon occurrence of a thermal even within one or more of the plurality of battery cells, the cover deforms inward toward the plurality of battery cells, and wherein the battery cover includes one or more vents to enable gas to pass out of the module

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a cross-section schematic of a module cover of the prior art for a module undergoing a thermal event;

FIG. 2 is a perspective view of a schematic of a battery module;

FIG. 3 is a partial cross section view of a schematic of a battery module across A-A′ of FIG. 2;

FIG. 4 is a is a partial cross section view of a schematic of a battery module undergoing a thermal event across A-A′ of FIG. 2;

FIG. 5A is a cross-section schematic of an example of a module cover as disclosed herein; and

FIG. 5B-D are cross-section schematics of examples of a module cover as disclosed herein undergoing a thermal event.

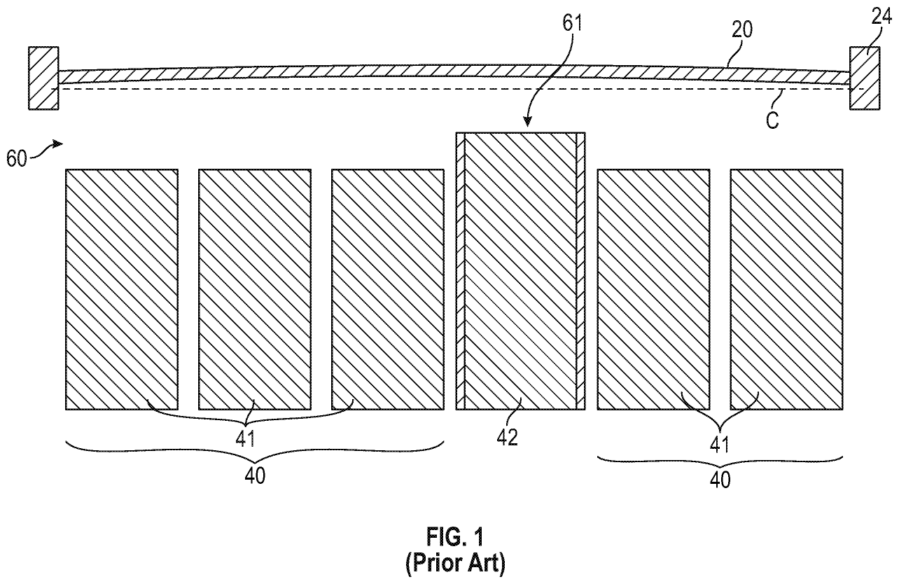

### DETAILED DESCRIPTION

The following description is merely exemplary in nature and is not intended to limit the present disclosure, its application or uses. It should be understood that throughout the drawings, corresponding reference numerals indicate like or corresponding parts and features.

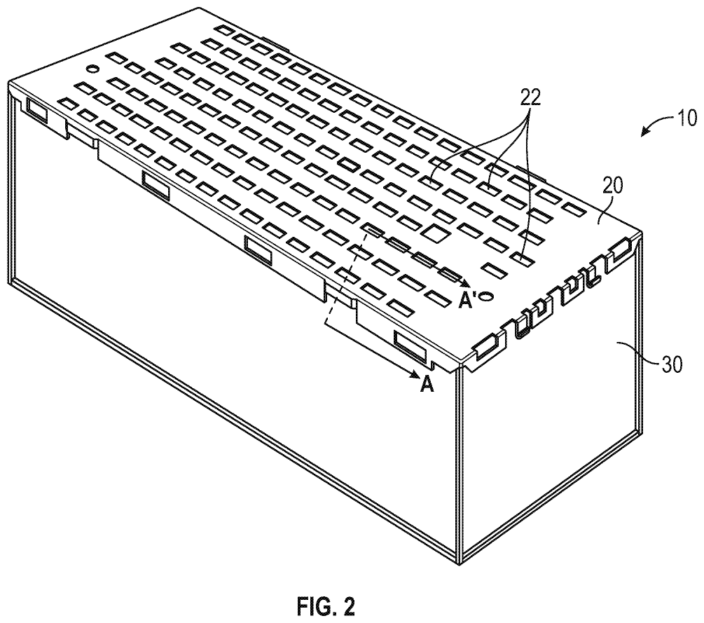

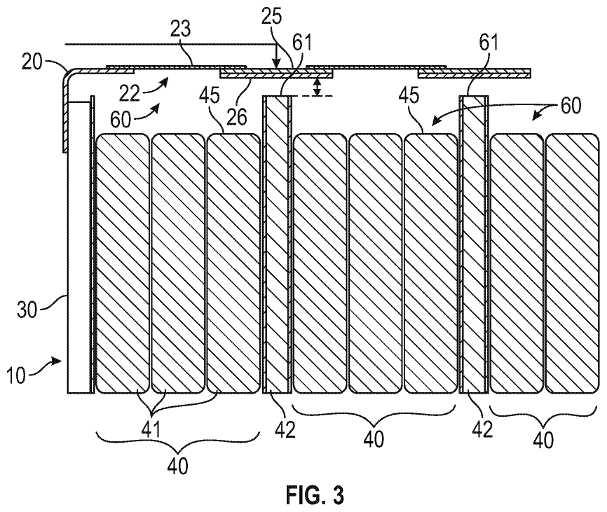

In accordance with an exemplary embodiment, as shown in FIG. 2, a battery module 10 incudes a container 30 and a cover 20. The cover may include optional vents 22. Within the container 30, as shown in FIG. 3, are multiple groups 40 of cells 41 where each group 40 is separated from an adjacent group 40 by a thermal barrier 42. The thermal barrier extends beyond a top edge 45 of the cells 41 into a gap 60. The cover 20 is located above the cells 41 and the thermal barrier 42 with a small gap 61 between the top of the thermal barrier 42 and the cover 20. The cover 20 can optionally include one or more vents 22. The vents 22 can optionally include a vent cover 23 which breaks or is removed by a thermal event occurring under such vent cover 23. The vent cover 23 can, for example, comprise a thin flexible sheet of a material such as mica. The cover 20 includes an outer layer 25 and an inner layer 26.

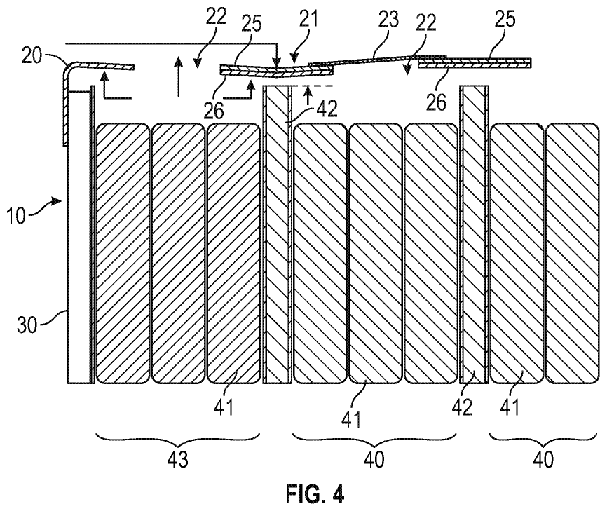

As shown in FIG. 4, in the event of a thermal event in one of the groups 43 of cells 41, the dual layer structure of the cover 20 causes the cover to deform inwardly. This inward deformation can shrink or close the gap 61 above the thermal barrier 42, thus inhibiting propagation of the thermal event into other cell groups 40.

The inward deformation can be a result of the inner layer 26 being closer than the outer layer 25 to the thermal event and thus heats and expands more quickly than outer layer 25 causing inward deformation. In addition or alternatively, the inner layer 26 can have a higher coefficient of thermal expansion than the outer layer 25 causing more or more rapid expansion of the inner layer causing inward deformation.

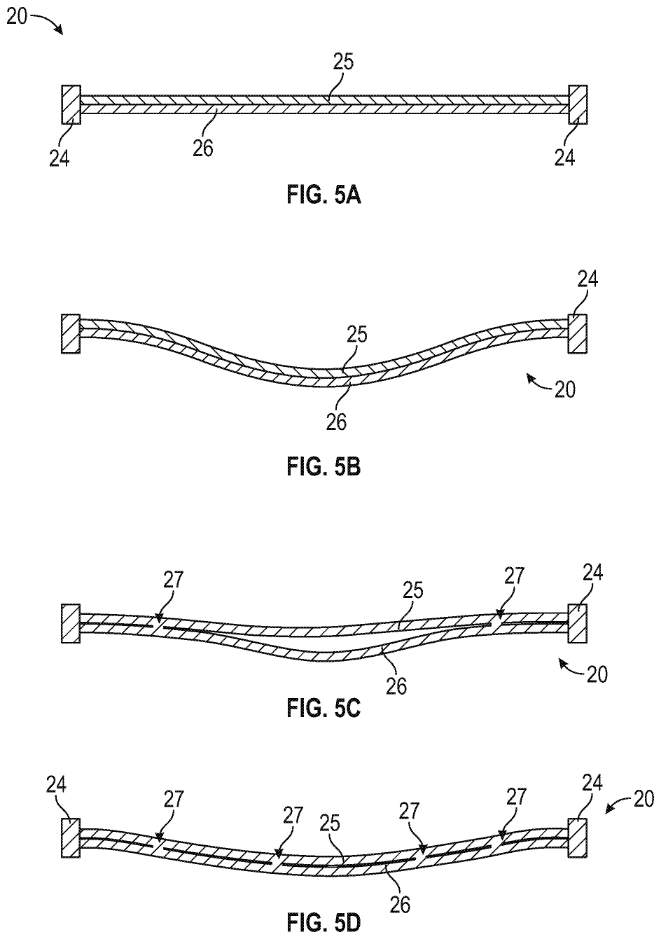

As an example of the structure, FIG. 5A shows a cover 20 having the inner layer 26 and the outer layer 25 that are physically connected at two or more affixation locations 24. The connection of the inner layer 26 and the outer layer 25 at the affixation locations 24 is required to cause inward deformation of the cover 20 upon expansion of the inner layer 26 in a thermal event.

As shown in FIG. 5B, the inner layer 26 and the outer layer 25 may be physically connected throughout a continuous portion of the cover 20. That continuous portion may be the entire cover 20. As shown in FIGS. 5C and 5D, the inner layer 26 and the outer layer 25 may be physically connected at individual isolated connection locations 27 spaced across the cover 20. These individual isolated connection locations can be, for example, welds (e.g., weld spots or weld lines).

The physical connection of the inner layer 26 and the outer layer 25 can be accomplished by such bonding methods as roll-bonding, cladding (e.g., zinc cladding), mechanical attachments, such as welding, or laminating with the use of an intermediate material between the inner layer 26 and the outer layer 25, or a combination thereof. The intermediate material can be, for example, an adhesive or an insulating material. The intermediate material can be sacrificial such that it decomposes upon occurrence of the thermal event. The intermediate material should be able to withstand normal operating temperatures for the battery module (e.g., −50° C. to 120° C., or −40° C. to 90° C.).

The inner layer 26 and the outer layer 25 may be formed from the same material. In this instance the inward deformation is caused by the more rapid heating and expansion of the inner layer 26 due to its proximity to the thermal event. The inner layer 26 and the outer layer 25 may be formed from different materials. If different materials are used, the inner layer 26 can be formed from a material having a higher coefficient of thermal expansion than the material used for the outer layer 25. The material selected for the inner layer 26 and the outer layer 25 must withstand both normal operating temperatures for the battery module and at least initial temperatures from a thermal event. For example, the materials used for the inner layer 26 and the outer layer 25 can have a melting point of greater than 500° C., or at least 600, at least 700, at least 800, at least 900, at least 1000, or at least 1100° C.

Examples of materials that can be used to form the inner layer 26 and the outer layer 25 are steel (e.g., stainless steel, such as ferritic stainless steel or austenitic stainless steel; carbon steel; galvanized steel' and aluminized steel), zinc, copper, copper-based alloys. For example, the combination of inner layer 26 and outer layer 25 can be a coated steel (e.g., carbon steel) where the coating can be zinc-based such as pure Zn, Zn—Fe, Zn—Ni, Zn—Mg, Zn—Mg—Al or aluminum-based such as Al—Si or Al—Zn. As another example, the outer layer 25 can be a carbon steel and the inner layer a stainless steel. As another example, both the inner layer 26 and the outer layer 25 can be a carbon steel.

The thickness of the cover can be, for example, greater than 0.4, at least 0.5, at least 0.6, at least 0.7, at least 0.8, at least 0.9 or at least 1 up to 5, up to 4, up to 3, up to 2, or up to 1.5 millimeters (mm). The inner layer 26 and the outer layer 25 can have the same thickness or different thicknesses. According to one exemplary embodiment the inner layer 26 is thicker than the outer layer 25. This structure can lead to more inward deflection of the cover. According to another exemplary embodiment the inner layer 26 is thinner than the outer layer 25. The thickness of the inner layer 26 and the outer layer 25 can individually greater than 0.1, greater than 0.15, greater than 0.2, greater than 0.25, at least 0.3, at least 0.4, at least 0.5, at least 0.6, at least 0.7, at least 0.8 up to 4, up to 3.5, up to 3 mm.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery module comprising
a container,
a plurality of battery cells within the container, and
a cover attached to sides of the container and extending in a plane over the plurality of battery cells wherein the cover comprises an inner layer and an outer layer.

2. The battery module of claim 1 further comprising a thermal barrier separating a first group of the plurality of battery cells from a second group of the plurality of battery cells.

3. The battery module of claim 2 wherein there is a gap between the cover and a top edge of the plurality of battery cells and the thermal barrier extends upward into the gap toward the cover.

4. The battery module of claim 1 wherein upon occurrence of a thermal even within one or more of the plurality of battery cells, the cover deforms inward toward the plurality of battery cells.

5. The battery module of claim 1 wherein the inner layer is attached to the outer layer in at least two fixation locations.

6. The battery module of claim 5 wherein the at least two fixation locations are at two opposing edges of the cover.

7. The battery module of claim 6 wherein the inner layer is attached to the outer layer at one or more additional locations within a periphery of the cover.

8. The battery module of claim 7 wherein the attachment of the inner layer to the outer layer at the one or more additional locations within the periphery of the covers comprises weld points.

9. The battery module of claim 1 wherein the inner layer is attached to the outer layer by a laminating material located between the inner layer and the outer layer.

10. The battery module of claim 9 wherein the laminating material comprises an adhesive material, an insulating material, or both.

11. The battery module of claim 1 wherein the inner layer is attached to the outer layer by roll-bonding.

12. The battery module of claim 1 wherein the inner layer and the outer layer comprise a same material.

13. The battery module of claim 1 wherein the inner layer comprises a first material and the outer layer comprises a second material.

14. The battery module of claim 13 wherein the first material and the second material are a metal.

15. The battery module of claim 14 wherein the metal is selected independently for each of the inner layer and the outer layer from steel, copper, and zinc.

16. The battery module of claim 13 wherein a coefficient of thermal expansion of the inner layer is larger than a coefficient of thermal expansion of the outer layer.

17. The battery module of claim 1 wherein the cover has a thickness of 0.4 to 5 mm.

18. The battery module of claim 1 wherein the inner layer has a thickness of 0.2 to 2.5 mm and the outer layer has a thickness of 0.1 to 2.5 mm.

19. The battery module of claim 1 wherein a thickness of the inner layer is larger than a thickness of the outer layer.

20. A battery module comprising
a container,
a plurality of battery cells within the container,
a thermal barrier separating a first group of the plurality of battery cells from a second group of the plurality of battery cells, and
a cover attached to sides of the container and extending in a plane over the plurality of battery cells wherein the cover comprises an inner layer and an outer layer wherein the inner layer is attached to the outer layer in at least two fixation location,
wherein there is a gap between the cover and a top edge of the plurality of battery cells and the thermal barrier extends upward into the gap toward the cover,
wherein upon occurrence of a thermal even within one or more of the plurality of battery cells, the cover deforms inward toward the plurality of battery cells, and
wherein the battery cover includes one or more vents to enable gas to pass out of the module.
